(19) United States
(12) Patent Application Publication
(10) Pub. No.: US 2007/0023210 A1
(43) Pub. Date: Feb. 1, 2007

(54) Electrical system of a mobile machine

(75) Inventors: John Jay Bernardi, Chillicothe, IL (US); Brian Todd Morrical, Peoria, IL (US); Kevin Dee Ehrenhardt, Eureka, IL (US); Timothy Allen Goldammer, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/190,952

(22) Filed: Jul. 28, 2005

(51) Int. Cl. B60K 1/00

(52) U.S. Cl. 180/65.2

(57) ABSTRACT

A mobile machine includes a propulsion system configured to propel the mobile machine. The mobile machine may also include an electrical system mounted to the machine. The electrical system may include a first power source, a second power source, a power-transmission system connected to one or more power loads, and power-supply controls. The power-supply controls may be configured to execute a control method, including executing a power-source transition. Executing the power-source transition may include disconnecting the first power source from the power-transmission system, waiting for satisfaction of at least one predetermined condition, and connecting the second power source to the power-transmission system.

### TECHNICAL FIELD

The present disclosure relates to electrical systems and, more particularly, to electrical systems of mobile machines.

### BACKGROUND

Mobile machines often include electrical systems for facilitating operation of the mobile machine and increasing the comfort of an operator of the mobile machine. Such electrical systems may include one or more power sources that produce electrical power, one or power-consuming devices, and power-transmission systems for transmitting power from the power sources to the power-consuming devices. Electrical systems having multiple power sources may include provisions for enabling an operator to selectively activate and deactivate different power sources to meet the needs of different circumstances. Unfortunately, such manual activation and deactivation of different power sources in response to changing circumstances may undesirably burden an operator of the mobile machine.

U.S. Patent Application No. 2003/0105567 (“the '567 application”), filed on Nov. 28, 2001, discloses a mobile machine having an electrical system with multiple power sources and provisions for automatically activating and deactivating different power sources depending upon operating conditions of the electrical system. The power sources of the electrical system disclosed by the '567 application include a battery, a motor generator, and an external power connector configured to connect to an external source of power. When the external power connector is supplying power and the motor/generator is not, electrical system controls detect power deficits by comparing power demands of the electrical system to the power capacity of the external power source. If a power deficit arises under such circumstances and the motor generator has a higher power capacity than the external power source, the electrical system automatically deactivates the external power connector and activates the motor generator.

Although the electrical system of the '567 application automatically activates and deactivates different power sources in response to changing power needs, certain disadvantages persist. For example, the electrical system includes no provisions for preventing undesirable transient events when transitioning from one combination of active power sources to another. Additionally, with the exception of the ability to store fault codes and activate alarms, the electrical system described in the '567 application does not include provisions for responding to malfunctions of the power sources.

The control methods of the present disclosure solve one or more of the problems set forth above.

### SUMMARY OF THE INVENTION

One disclosed embodiment relates to a mobile machine, which may include a propulsion system configured to propel the mobile machine. The mobile machine may also include an electrical system mounted to the machine. The electrical system may include a first power source, a second power source, a power-transmission system connected to one or more power loads, and power-supply controls. The power-supply controls may be configured to execute a control method, including executing a power-source transition. Executing the power-source transition may include disconnecting the first power source from the power-transmission system, waiting for satisfaction of at least one predetermined condition, and connecting the second power source to the power-transmission system.

Another embodiment relates to a method for operating an electrical system of a mobile machine. The electrical system may include a prime-mover-driven motor/generator, a second power source, a power-transmission system, and a plurality of power loads connected to the power-transmission system. The method may include receiving inputs relating to operating conditions of the machine. Additionally, the method may include connecting the prime-mover-driven motor/generator to the power-transmission system under a first set of predetermined conditions, including receipt of inputs indicating that the prime-mover-driven motor/generator is currently capable of supplying power. Furthermore, the method may include connecting the second power source to the power-transmission system under a second set of predetermined conditions, including at least one of receipt of inputs indicating that the prime-mover-driven motor/generator is not currently capable of supplying power and receipt of inputs indicating that the prime-mover-driven motor/generator may be malfunctioning.

A further embodiment may relate to a mobile machine, which may include a propulsion system configured to propel the mobile machine. The mobile machine may also include an electrical system mounted to the mobile machine. The electrical system may include a first power source, a second power source, a power-transmission system, one or more power loads connected to the power-transmission system, and power-source controls. The power-source controls may be configured to execute a control method, which may include connecting the first power source to the power-transmission system and receiving inputs related to the performance of the first power source. Additionally, the method may include, in response to receipt of inputs indicating that the first power source is malfunctioning, disconnecting the first power source from the power-transmission system, connecting the second power source to the power-transmission system, and, subsequently, maintaining the first power source disconnected from the power-transmission system at least until receipt of one or more predetermined inputs from an operator.

### BRIEF DESCRIPTION OF THE DRAWINGS

FIG. 1 is a schematic illustration of a mobile machine according to one disclosed embodiment;

FIG. 2 is a flow chart illustrating one embodiment of a method for determining which of a plurality of power sources is currently preferred;

FIG. 3 is a flow chart illustrating one embodiment of a method for controlling which of a plurality of power sources is connected to a power-transmission system of an electrical system;

FIG. 4 is a flow chart illustrating one embodiment of a fault-monitoring method for an electrical system; and

### DETAILED DESCRIPTION

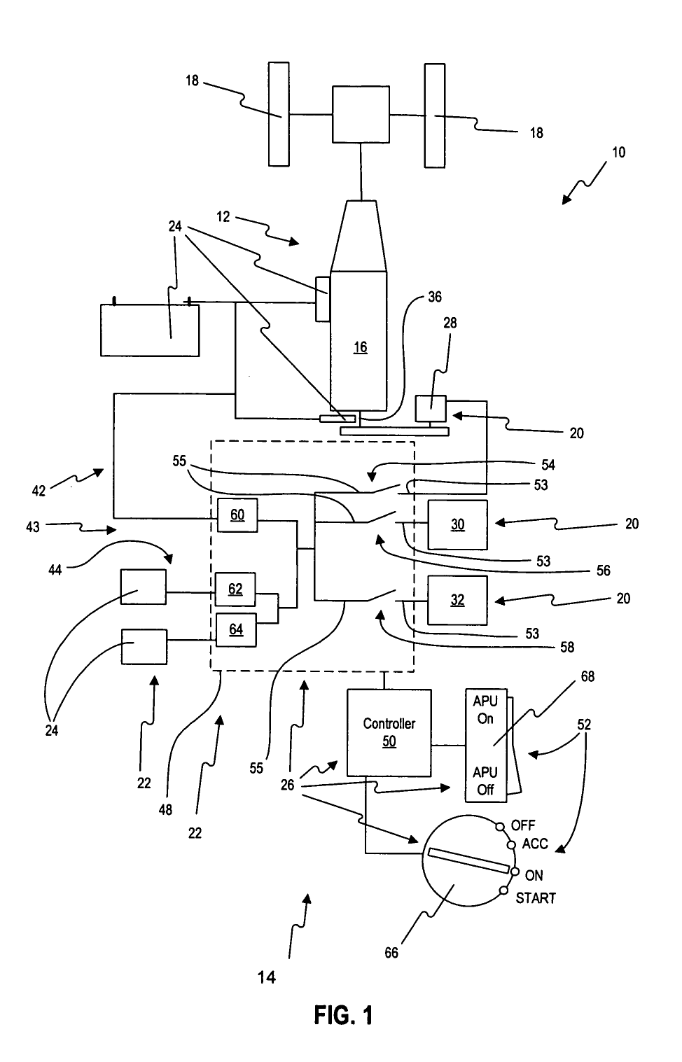

FIG. 1 provides a schematic view of a mobile machine 10. Mobile machine 10 may include a propulsion system 12 and an electrical system 14. While FIG. 1 shows mobile machine 10 as land-based, mobile machine 10 may be a water vessel or an aircraft.

Propulsion system 12 may include a prime mover 16 and propulsion devices 18. Prime mover 16 may be any type of device configured to produce power for propelling mobile machine 10, including, but not limited to, a diesel engine, a gasoline engine, a gaseous fuel driven engine, and a turbine. Propulsion devices 18 may be any type of component configured to receive power produced by prime mover 16 and utilize that power to propel mobile machine 10. For example, propulsion devices 18 may be wheels, track units, or a propeller.

Electrical system 14 may include one or more power sources 20, a power-transmission system 22, one or more power loads 24, and power-supply controls 26. Power sources 20 may be configured to produce electrical power. Power-transmission system 22 may be configured to receive power from power sources 20 and distribute that power to power loads 24. Power loads 24 may be configured to receive power from power-transmission system 22 and facilitate operation of mobile machine 10 and/or perform various functions that improve the comfort, convenience, and overall satisfaction of an operator of mobile machine 10. Power-supply controls 26 may be configured to control various aspects for operation of electrical system 14, including which of power sources 20 are connected to and supply power to power-transmission system 22.

Power sources 20 may include a prime-mover-driven motor/generator 28, a shore power interface 30, and an auxiliary power unit 32. Prime-mover-driven motor/generator 28 may be mechanically coupled to an output shaft 36 of prime mover 16 and configured to convert power received from output shaft 36 into electricity. Shore power interface 30 may include one or more power receptacles for connecting to external sources of power including utility power (e.g. electric grid), an external generator, an external battery, power connections supplied by third parties (e.g. campgrounds, truck stops, rest areas, marinas, airports, etc.), or any other external source of power. Shore power interface 30 may include receptacles configured to receive 110 volt ac power, 220 volt ac power, and/or dc power. Auxiliary power unit 32 may include an engine (not shown) mounted to mobile machine 10, such as a diesel engine, a gasoline engine, a gaseous fuel driven engine, or a turbine engine, and an additional motor/generator (not shown) mechanically connected to the engine.

Power-transmission system 22 may include a power electronics module 48 and a transmission network 43. Power electronics module 48 may include a first switching device 54, a second switching device 56, and a third switching device 58 for selectively connecting power electronics module 48 to prime-mover-driven motor/generator 28, shore power interface 30, and auxiliary power unit 32, respectively. First, second, and third switching devices 54, 56, 58 may each include an input side 53 and output side 55. Additionally, power electronics module 48 may include one or more power adjusters 60, 62, 64 configured to adjust the amount and/or form of power provided to various portions of transmission network 43. A first portion 42 of transmission network 43 may extend from power adjuster 60, and a second portion 44 of transmission network 43 may extend from power adjusters 62, 64.

Power-supply controls 26 may include power electronics module 48, a controller 50, and operator controls 52. Controller 50 may include one or more processors (not shown) and one or more memory devices (not shown). Controller 50 may be communicatively linked to various sensors and/or other controllers of mobile machine 10, so as to receive inputs relating to operating conditions of mobile machine 10 and electrical system 14. Controller 50 may be configured to control the operation of power electronics module 48. Controller 50 may be a dedicated controller for controlling the supply of power to power-transmission system 22. Alternatively, controller 50 may be configured to monitor and/or control other aspects of mobile machine 10.

Operator controls 52 may include a mode selector 66 and an APU enabler 68. Mode selector 66 may be configured to allow an operator to request one of a plurality for operating states of electrical system 14, including an inactive operating state and one or more active operating states. For example, an operator may request an inactive operating state by placing mode selector 66 in the “OFF” position, or request an inactive operating state by placing mode selector 66 in one of the “ACC,” “ON,” and “START,” operating states. APU enabler 68 may be configured to allow an operator to request that auxiliary power unit 32 be enabled or disabled as a source of power for electrical system 14. As is shown in FIG. 1, APU enabler 68 may be a switch, with one operating state corresponding to a request for enablement, and another operating state corresponding to a request for disablement.

Power-supply controls 26 are not limited to the embodiment illustrated in FIG. 1. For example, power-supply controls 26 may implement hardwired logic circuitry and/or other logical devices in addition to, or in place of, controller 50. Power-supply controls 26 may also include other controllers in addition to controller 50, and the control logic of power-supply controls 26 may be distributed between controller 50 and any such other controllers. Additionally, in contrast to the embodiment shown in FIG. 1, first, second, and third switching devices 54, 56, 58, and power adjusters 60, 62, 64 may be physically dispersed, rather than located together. Furthermore, power-supply controls 26 may omit one or more of power adjusters 60, 62, 64 or include additional power adjusters.

### INDUSTRIAL APPLICABILITY

The disclosed embodiments have application in any mobile machine 10 including an electrical system 14. The operation of an electrical system 14 of a mobile machine 10 according to the disclosed embodiments is described below.

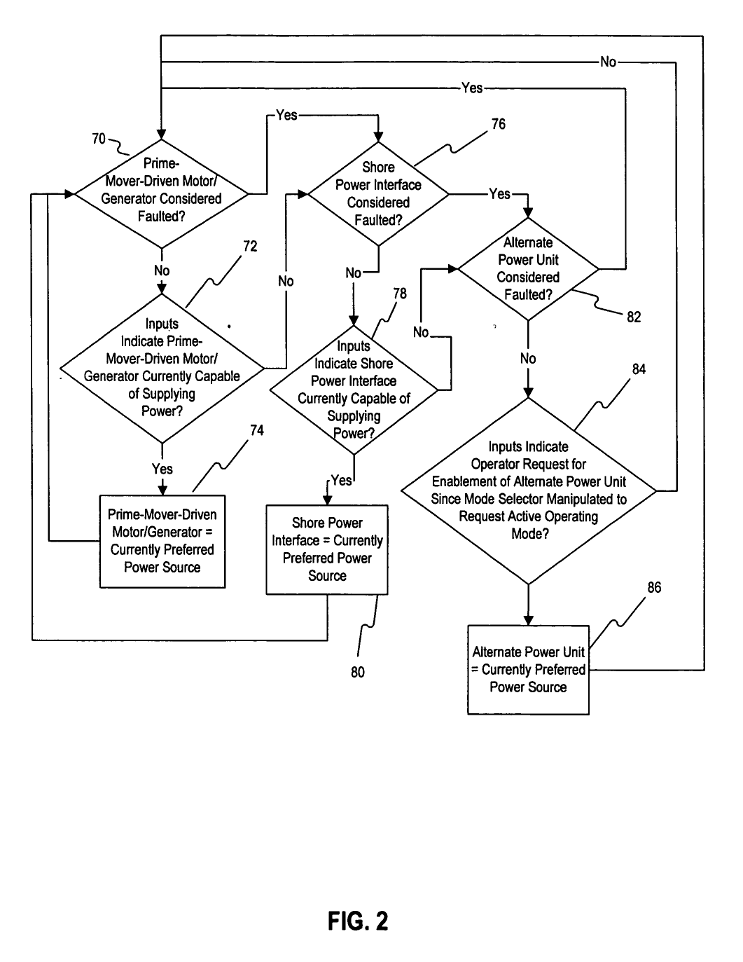

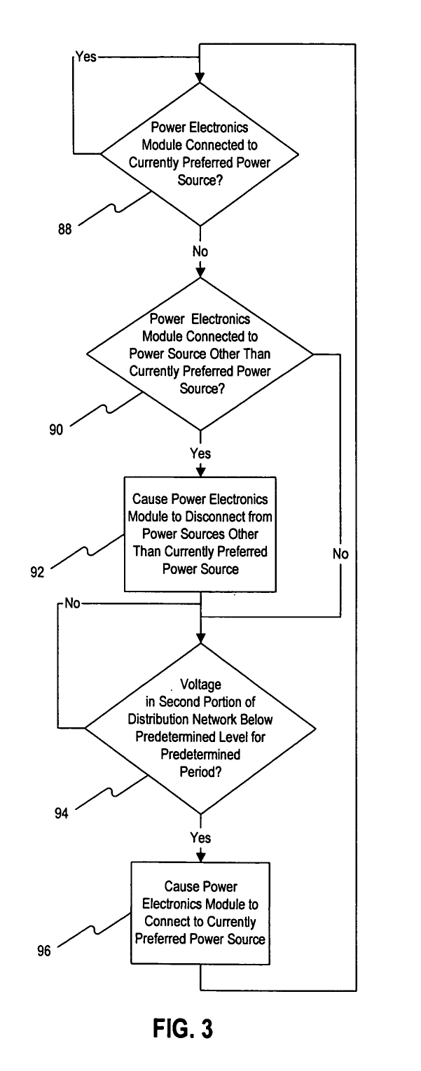

Power electronics module 48 may be connected to prime-mover-driven motor/generator 28, shore power interface 30, and/or auxiliary power unit 32 when first switching device 54, second switching device 56, and/or third switching device 58 are closed. In some embodiments, such as the ones described in connection with FIGS. 2 and 3, power-supply controls 26 may maintain power electronics module 48 connected to only one of power sources 20 at any one time. Any power sources 20 so connected to power electronics module 48 may provide power to power electronics module 48. Power adjusters 60, 62, and 64 may receive that power and transmit it to transmission network 43. Power adjuster 60 may supply power to first portion 42 of transmission network 43. Power adjusters 62, 64 may supply power to second portion 44 of transmission network 43. When power adjusters 62, 64 and the power sources 20 supplying them power are operating properly, power adjusters 62, 64 may supply power at a substantially constant voltage, such as 340 volts dc.

FIG. 2 is a flow chart illustrating one embodiment of a method according to which controller 50 may determine which of first, second, and third switching devices 54, 56, 58 should be closed to connect one of power sources 20 to power adjusters 60, 62, 64. According to a method such as the one illustrated in FIG. 2, power sources 20 may have a priority ranking, and the highest priority power source 20 that is considered enabled as a source of power, and not considered faulted, may be the currently preferred power source 20. Controller 50 may use different criteria to determine whether different power sources 20 should be considered enabled and, thus, available for supplying power to power-transmission network 22. Prime-mover-driven motor/generator 28 and shore power interface 30 may be considered enabled if inputs to controller 50 indicate that they are currently capable of supplying power. Auxiliary power unit 32 may be considered enabled if controller 50 receives certain inputs from an operator.

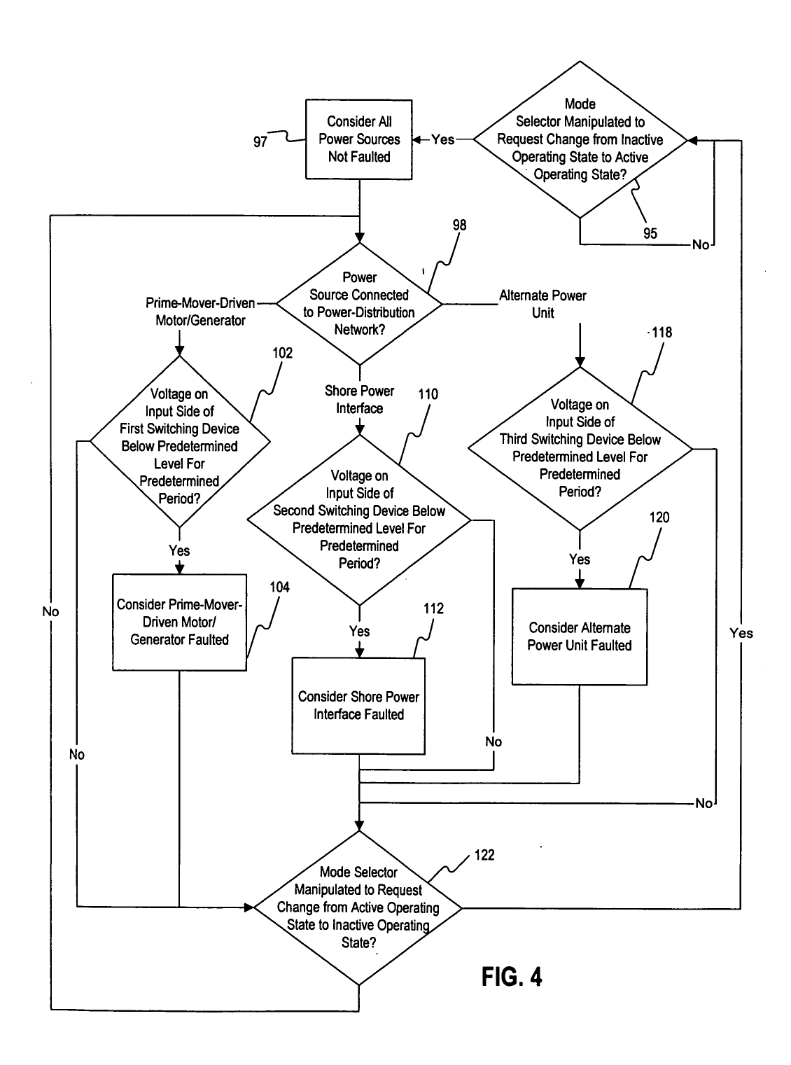

As FIG. 2 shows, in some embodiments, the first factor in determining which power source 20 is currently preferred may include whether prime-mover-driven motor/generator 28 is considered faulted (step 70). Generally, a power source 20 may be considered faulted if controller 50 has received inputs indicating that the power source 20 is malfunctioning. One method according to which controller 50 may determine whether a power source 20 should be considered faulted is discussed in greater detail below, in connection with FIG. 4. If prime-mover-driven motor/generator 28 is not considered faulted, controller 50 may determine whether inputs indicate that prime-mover-driven motor/generator 28 is currently capable of supplying power (step 72). In some embodiments, controller 50 may do so by determining whether inputs indicate that prime mover 16 is operating above a predetermined speed, such as 500 RPM. If so, prime mover 16 may be driving prime-mover-driven motor/generator 28 at a high enough speed to enable prime-mover-driven motor/generator 28 to supply power. If inputs indicate that prime-mover-driven motor/generator 28 is currently capable of supplying power, controller 50 may consider it to be enabled as a source of power and the currently preferred power source 20 (step 74). Controller 50 may then return to step 70 and iterate the process of determining which power source 20 is currently preferred.

If prime-mover-driven motor/generator 28 is not currently capable of supplying power or is considered faulted, the next factor in determining which power source 20 is currently preferred may be whether shore power interface 30 is considered faulted (step 76). If not, controller 50 may determine whether shore power interface 30 is currently capable of supplying power. Controller 50 may do so by determining whether inputs indicate that voltage is present in shore power interface 30 (step 78). If so, controller 50 may consider shore power interface 30 to be enabled as a source of power and the currently preferred power source 20 (step 80). Subsequently, controller 50 may return to step 70.

If neither prime-mover-driven motor/generator 28 nor shore power interface 30 is the currently preferred power source 20 and auxiliary power unit 32 is not considered faulted (step 82), controller 50 may determine whether auxiliary power unit 32 is enabled as a source of power. Controller 50 may do so by determining whether an operator has manipulated APU enabler 68 to request enablement of auxiliary power unit 32 since the last time the mode selector was manipulated to request that electrical system 14 shift from an inactive operating state to an active operating state (84). Requiring an operator to request enablement of auxiliary power unit 32 after each cycling of mode selector 66 may prevent an operator from unwittingly activating auxiliary power unit 32 when requesting an active operating state of electrical system 14. If controller 50 determines at step 84 that auxiliary power unit 32 is enabled, auxiliary power unit 32 may be the currently preferred power source 20 (step 86). After step 86, after an affirmative determination at step 82, or after a negative determination at step 84, controller 50 may return to step 70.

Embodiments, such as the one illustrated in FIG. 2, wherein prime-mover-driven motor/generator 28, shore power interface 30, and auxiliary power unit 32 have high, intermediate, and low priority rankings, respectively, may promote efficient energy utilization. When prime mover 16 is operating and prime-mover-driven motor/generator 28 is capable of supplying power, drawing power from prime mover 16 to produce electricity may be more energy efficient than consuming electricity from shore power interface 30 or auxiliary power unit 32. Additionally, shore power interface 30 may be more efficient than auxiliary power unit 32.

Methods of controlling which of power sources 20 is/are currently preferred are not limited to the embodiments discussed above in connection with FIG. 2. For example, control methods may include the possibility of more than one power source 20 being currently preferred. Additionally, in some embodiments the priority rankings of and enablement requirements for prime-mover-driven motor/generator 28, shore power interface 30, and auxiliary power unit 32 may be different.

While executing the method of FIG. 2 to determine which power source 20 is currently preferred, controller 50 may connect and disconnect power sources 20 from power electronics module 48 as necessary to maintain the currently preferred power source 20 connected to power electronics module 48. The flow chart of FIG. 3 illustrates one method according to which controller 50 may connect and disconnect power sources 20 to maintain the currently preferred power source 20 connected to power electronics module 48. Controller 50 may first determine whether the power source 20 that is the power source 20 currently connected to power electronics module 48 is the currently preferred power source 20 (step 88), as determined by execution of the method of FIG. 2. If so, controller 50 may simply iterate this determination. If power electronics module 48 is not connected to the currently preferred power source 20, controller 50 may determine whether power electronics module 48 is connected to a power source 20 other than the currently preferred power source 20 (step 90). For example, if the currently preferred power source 20 is prime-mover-driven motor/generator 28 and it is not connected to power electronics module 48, controller 50 may determine if power electronics module 48 is connected to shore power interface 30 and/or auxiliary power unit 32, or disconnected from all power sources 20. If power electronics module 48 is connected to a power source 20 other than the currently preferred power source 20, controller 50 may cause power electronics module 48 to disconnect from that power source 20 (step 92).

Once all power sources 20 other than the currently preferred one are disconnected from power electronics module 48, controller 50 may wait until the voltage in first portion 42 of transmission network 43 has been below a predetermined level, such as 150 volts, for a predetermined period, such as 2 seconds (step 94). Controller 50 may then cause power electronics module 48 to connect to the currently preferred power source 20 (step 96). Waiting for the voltage to drop in first portion 42 of transmission network 43 before connecting a different power source 20 may help avoid undesirable transient events, such an over-voltage condition, that could damage one or more components of electrical system 14.

FIG. 4 illustrates one embodiment of a fault-monitoring method for determining whether any of power sources 20 should be considered faulted. Controller 50 may begin execution of the method when an operator manipulates mode selector 66 to request a change from an inactive operating state to an active operating state (step 95). Controller 50 may initially consider all power sources 20 not faulted (step 97). If power electronics module 48 is connected to prime-mover-driven motor/generator 28 (step 98), controller 50 may determine whether the voltage on input side 53 of first switching device 54 has been below a predetermined level, such as 150 volts, for a predetermined period, such as 15 seconds (step 102). If so, this may indicate that prime-mover-driven motor/generator 28 has an ongoing problem, and controller 50 may consider prime-mover-driven motor/generator faulted (step 104). If power electronics module 48 is connected to shore power interface 30 or auxiliary power unit 32, controller 50 may execute similar steps, such as steps 110 and 112 or steps 118 and 120, respectively, to determine whether shore power interface 30 or auxiliary power unit 32 should be considered faulted.

After determining whether the power source 20 currently connected to power-electronics module 48 should be considered faulted, controller 50 may determine whether mode selector 66 has been manipulated to request a change from an active operating state to an inactive operating state (122). If not, controller 50 may iterate the process of determining whether the power source 20 currently connected to power electronics module 48 should be considered faulted. In some embodiments, such as the ones discussed in connection with FIGS. 2 and 3, a power source 20 that is considered faulted cannot be the currently preferred power source 20, and controller 50 will disconnect it from power electronics module 48 and maintain it disconnected therefrom unless controller 50 subsequently considers it not faulted. If controller 50 determines at step 122 that mode selector 66 has been manipulated to request an inactive operating state, controller 50 may wait unit mode selector 66 has again been manipulated to request an active operating state (step 95), before resuming the fault-monitoring process.

It will be apparent to those of ordinary skill in the art that various modifications and variations can be implemented with electrical system 14 and the disclosed methods for operating it without departing from the scope of the disclosure. Other embodiments will be apparent to those skilled in the art from consideration of the specification and practice of the electrical system 14 and the disclosed methods for operating it. It is intended that the disclosure of these embodiments be considered as exemplary only, with a true scope of the invention being indicated by the following claims and their equivalents.

What is claimed is:

1. A mobile machine, comprising:
a propulsion system configured to propel the machine;
an electrical system mounted to the machine, wherein the electrical system includes:
a first power source;
a second power source;
a power-transmission system connected to one or more power loads;
power-supply controls configured to execute a control method, including:
executing a power-source transition, including:
disconnecting the first power source from the power-transmission system;
waiting for satisfaction of at least one predetermined condition; and
connecting the second power source to the power-transmission system.

2. The mobile machine of claim 1, wherein the control method further includes determining whether the first power source should be connected to the power-transmission system dependent upon one or more operating conditions of the propulsion system.

3. The mobile machine of claim 1, wherein the one or more power loads connected to the power-transmission system include one or more components of the propulsion system.

4. The mobile machine of claim 1, wherein the predetermined condition relates to the state of electrification of at least one portion of the power-transmission system.

5. The mobile machine of claim 1, wherein the predetermined condition includes the voltage level in a portion of the power-transmission system dropping below a predetermined level.

6. The mobile machine of claim 1, wherein the predetermined condition includes the voltage level in a portion of the power-transmission system dropping below a predetermined level for a predetermined period.

7. The mobile machine of claim 1, wherein the power-supply controls are configured to cause only one of the first power source and the second power source to supply power to the power-transmission system at any given time.

8. The mobile machine of claim 7, wherein the predetermined condition relates to a state of electrification of the power-transmission system.

9. The mobile machine of claim 7, wherein the predetermined condition includes the voltage in a portion of the power-transmission system dropping below a predetermined level.

10. The mobile machine of claim 7, wherein:
the first and second power sources include two of a prime-mover-driven motor generator type power source, a shore power interface type power source, and an auxiliary power unit type power source; and
the first and second power sources are different types of power sources.

11. The mobile machine of claim 1, wherein:
the first and second powers source include two of a prime-mover-driven motor generator type power source, a shore power interface type power source, and an auxiliary power unit type power source; and
the first and second power sources are different types of power sources.

12. The mobile machine of claim 1, wherein the control method includes initiating the power-source transition when the first power source is connected to the power-transmission network, the second power-source is disconnected from the power-transmission network, and the power-source controls determine that supplying power with the second power source is preferable to supplying power with the first power source.

13. A method for operating an electrical system of a mobile machine, which electrical system includes a prime-mover-driven motor/generator power source, a second power source, a power-transmission system, and a plurality of power loads connected to the power-transmission system, the method comprising:
receiving inputs relating to operating conditions of the mobile machine;
connecting the prime-mover-driven motor/generator to the power-transmission system under a first set of predetermined conditions, including receipt of inputs indicating that the prime-mover-driven motor/generator is currently capable of supplying power; and
connecting the second power source to the power-transmission system under a second set of predetermined conditions, including at least one of receipt of inputs indicating that the prime-mover-driven motor/generator is not currently capable of supplying power and receipt of inputs indicating that the prime-mover-driven motor/generator may be malfunctioning.

14. The method of claim 13, wherein inputs indicating that the prime-mover-driven motor/generator is not currently capable of supplying power include inputs indicating that a prime mover of the mobile machine is not operating.

15. The method of claim 14, wherein inputs indicating that the prime-mover-driven motor/generator is currently capable of supplying power include inputs indicating that the prime mover is operating.

16. The method of claim 13, wherein inputs indicating that the prime-mover-driven motor/generator is currently capable of supplying power include inputs indicating that a prime mover of the mobile machine is operating.

17. The method of claim 13, wherein the second power source is at least one of a shore power interface and an auxiliary power unit.

18. The method of claim 13, wherein the second set of predetermined conditions further includes receipt of predetermined inputs indicating the second power source is enabled as a source of power for the electrical system.

19. The method of claim 18, wherein the predetermined inputs indicating the second power source is enabled as a source of power for the electrical system include at least one of inputs indicating that the second power source is currently capable of supplying power and inputs indicating that an operator desires to enable the second power source as a source of power for the electrical system.

20. The method of claim 13, wherein the second power source is a shore power interface.

21. The method of claim 13, further including:
connecting a third power source to the power-transmission system under a third set of predetermined conditions, including at least one of receipt of inputs indicating that the first power source is not currently capable of supplying power and receipt of inputs indicating that the prime-mover-driven motor/generator may be malfunctioning, and wherein the third set of predetermined conditions further includes at least one of receipt of predetermined inputs indicating the second power source is not enabled as a source of power for the electrical system, and receipt of inputs indicating that the second power source may be malfunctioning.

22. The method of claim 21, wherein the second power source is a shore power interface and the third power source is an auxiliary power unit.

23. The method of claim 21, wherein the third power source is an auxiliary power unit and the third set of predetermined conditions further includes receipt of inputs from an operator indicating that the operator desires enablement of the auxiliary power unit as a source of power for the electrical system.

24. A mobile machine, comprising:
a propulsion system configured to propel the mobile machine; and
an electrical system mounted to the mobile machine, wherein the electrical system includes:
a first power source;
a second power source;
a power-transmission system;
one or more power loads connected to the power-transmission system; and
power-source controls configured to execute a control method, including:
connecting the first power source to the power-transmission system;
receiving inputs related to the performance of the first power source; and
in response to receipt of inputs indicating that the first power source is malfunctioning:
disconnecting the first power source from the power-transmission system;
connecting the second power source to the power-transmission system; and
subsequently, maintaining the first power source disconnected from the power-transmission system at least until receipt of one or more predetermined inputs from an operator.

25. The mobile machine of claim 24, wherein the control method further includes determining whether the first power source should be connected to the power-transmission system dependent upon one or more operating conditions of the propulsion system.

26. The mobile machine of claim 24, wherein the one or more power loads connected to the power-transmission system include one or more components of the propulsion system.

27. The mobile machine of claim 24, wherein the one or more predetermined inputs from an operator include manipulation of a mode selector of the electrical system to request an inactive operating state of the electrical system.

28. The mobile machine of claim 27, wherein inputs indicating that the first power source is malfunctioning include predetermined inputs related to a state of electrification of the power-transmission system.

29. The mobile machine of claim 27, wherein inputs indicating that the first power source is malfunctioning include inputs indicating that the voltage in a portion of the electrical system that the first power source is connected to is outside a predetermined range.

30. The mobile machine of claim 24, wherein:
connecting the first power source to the power-transmission system includes connecting the first power source to the power-transmission system only after receipt of predetermined inputs indicating the first power source is enabled as a source of power for the electrical system; and
connecting the second power source to the power-transmission system includes connecting the second power source to the power-transmission system only after receipt of predetermined inputs indicating the second power source is enabled as a source of power for the electrical system.

31. The mobile machine of claim 24, wherein inputs indicating that the power source may be malfunctioning include inputs indicating that the voltage in a portion of the electrical system that the first power source is connected to is outside a predetermined range.
